(19) United States
(12) Patent Application Publication
(10) Pub. No.: US 2013/0111551 A1
(43) Pub. Date: May 2, 2013

(54) Method for Securing Computers from Malicious Code Attacks

(71) Applicants: Richard Dellacona, Corona Del Mar, CA (US); Robert Arnon, Newport Beach, CA (US)

(72) Inventors: Richard Dellacona, Corona Del Mar, CA (US); Robert Arnon, Newport Beach, CA (US)

(21) Appl. No.: 13/452,754

(22) Filed: Apr. 20, 2012

Related U.S. Application Data
(63) Continuation-in-part of application No. 11/118,010, filed on Apr. 29, 2005, now abandoned.

(51) Int. Cl. G06F 21/60

(52) U.S. Cl. CPC G06F 21/60
USPC 726/3

(57) ABSTRACT

A computer readable storage medium has instructions that, when executed by a host computer cause the host computer to perform a method of write protecting the storage medium and therefore preventing a non-registered user from changing the permissions log file. The instructions include: writing copies of control files of the host computer into the protected memory, writing a copy of a user permissions log file of the host computer into the protected memory, and changing a startup execute path function of the host computer to initially read the copy of the user permissions log file in the protected memory; and opening a write controlling circuit path to prevent access to changing the permissions log file.

### CROSS-REFERENCE TO RELATED APPLICATIONS

This application is a continuation-in-part application co-pending with non-provisional parent patent application Ser. No. 11/118,010, filed on Apr. 29, 2005, and claims international date priority therefrom. The subject matter of application Ser. No. 11/118,010 is hereby incorporated hereinto in its entirety.

Federally sponsored research-development, reference to sequence listings, and computer program listings, are not applicable to thus application.

### BACKGROUND

This disclosure relates to the field of computer security and more particularly to a method of safeguarding a computer from unauthorized use. The well-known Federal information Security Management Act Of 2002 (FISMA) is a United States federal law recognizing the importance of information security to the economic and national security interests of the United States. Computer security is a branch of computer technology known as information security as applied to computers and networks. The objective of computer security includes protection of information and property from theft, corruption, or natural disaster, while allowing the information and property to remain accessible and productive to its intended users. The term computer device security means the collective processes and mechanisms by which sensitive and valuable information and services are protected from publication, tampering or collapse by unauthorized activities or untrustworthy individuals and unplanned events respectively. The strategies and methodologies of computer security often differ from most other computer technologies because of its somewhat elusive objective of preventing unwanted computer behavior instead of enabling wanted computer behavior.

Computers can be attacked, also referred to as “hacked.” An “active attack” attempts to alter system resources or affect their operation. A “passive attack” attempts to learn or make use of information from the system but does not affect system resources. Active and passive attacks are not mutually exclusive. Obviously, an attack can be perpetrated by both an insider or an outsider in relation to an organization. An inside attack is an attack initiated by an entity inside the security perimeter, i.e., an entity that is authorized to access system resources but uses them in a way not approved by those who granted the authorization. An outside attack is initiated from outside the perimeter, by an unauthorized or illegitimate user of the system. in the Internet, potential outside attackers range from amateur pranksters to organized criminals, international terrorists, and hostile governments. An attack usually is perpetrated by someone with bad intentions or by someone attempting to test a security system or perimeter. A “logical” attack (non-physical) is defined as using software in an attempt to force changes in the internal logic used by computers or network protocols in order to achieve unintended or undesirable results. Such software is often referred to as malware.

Various techniques are employed to foil attacks, the most common two being the software firewall and the anti-virus software, both resident on most computer systems. A firewall is a software device capable of permitting or denying network transmissions based upon a set of rules and is frequently used to protect networks from unauthorized access while permitting legitimate communications to pass. Many personal computer operating systems include software-based firewalls to protect against threats from the public Internet. Many routers that pass data between networks contain firewall components and, conversely, some firewalls are capable of performing basic routing functions. Common firewall types include: network layer or packet filters, application layers, proxies, and network address translation. It is well known that firewalls are regularly bypassed by sophisticated hackers.

Anti-virus software is used to prevent, detect, and remove malware, including but not limited to computer viruses, computer worms, Trojan horses, spyware and adware. Anti-virus software is used for the prevention and removal of such threats, rather than computer security implemented by software methods. A variety of strategies are typically employed. Signature-based detection involves searching for known patterns of data within executable code. However, it is possible for a computer to be infected with new malware for which no signature is yet known. To counter such so-called zero-day threats, heuristics can be used. One type of heuristic approach, generic signatures, can identify new viruses or variants of existing viruses by looking for known malicious code, or slight variations of such code, in files. Some antivirus software can also predict what a file will do by running it in a sandbox and analyzing what it does to see if it performs any malicious actions. Antivirus software can have drawbacks such as by impairing a computer's performance. Inexperienced users may also have trouble understanding the prompts and decisions that antivirus software presents them with. An incorrect decision may lead to a security breach. If the antivirus software employs heuristic detection, success depends on achieving the right balance between false positives and false negatives and both can be equally destructive. Finally, antivirus software generally runs at the highly trusted kernel level of an operating system, creating a potential avenue of attack.

Therefore, an improved solution to the above described problems is needed, a solution that is more effective than present-day practice and yet is inexpensive and simple to use. The following disclosure teaches such a method.

### BRIEF SUMMARY AND OBJECTIVES

A host computer, is protected from malicious attacks, as described above, by a novel method based on an electrical circuit which includes a manual physical switch and a protection algorithm stored in a protected memory. When initiated and executed, the protection algorithm copies the host's control files (read, write, and execute) and the host's authorized user log to the protected memory and modifies the host's execute control path to point initially to the copied user log. When the physical switch is in an open state, a circuit for writing to the copied user log is disabled so it is impossible to make any changes to the user log. This renders the system immune to malicious attacks since an unauthorized user is unable to log-in or assume the identity of an authorized user.

A primary objective and aspect of the present Circuit and method is to provide a relatively simple and inexpensive device which may be actively interfaced with a host to provide immunity to malicious attack.

Another aspect is to provide the device implemented as original equipment within the host to provide such immunity.

Another aspect is to provide an absolutely safe method of such protection.

Another aspect is to provide a software implementation of such protection with a physical switch for selecting protected periods and non-protected periods of use of the host.

The details of one or more embodiments of these concepts are set forth in the accompanying drawings and the following description. Other features, objects, and advantages of these concepts will be apparent from the description and drawings, and from the claims.

### BRIEF DESCRIPTION OF THE SEVERAL VIEWS OF THE DRAWING

FIG. 1 is an example logical flow diagram of a method of use of the presently described circuit;

FIG. 2 is an example embodiment concept diagram showing the presently described circuit including an integrated physical switch, the circuit removably interconnected with a host computer;

FIG. 3 is an example further embodiment concept diagram showing the circuit as permanently mounted within a host computer with its physical switch in a position for physical access by a user, and

FIG. 4 is art example concept diagram of several interconnecting schemes of the presently described circuit.

Like reference symbols in the various drawings indicate like elements.

### DETAILED DESCRIPTION

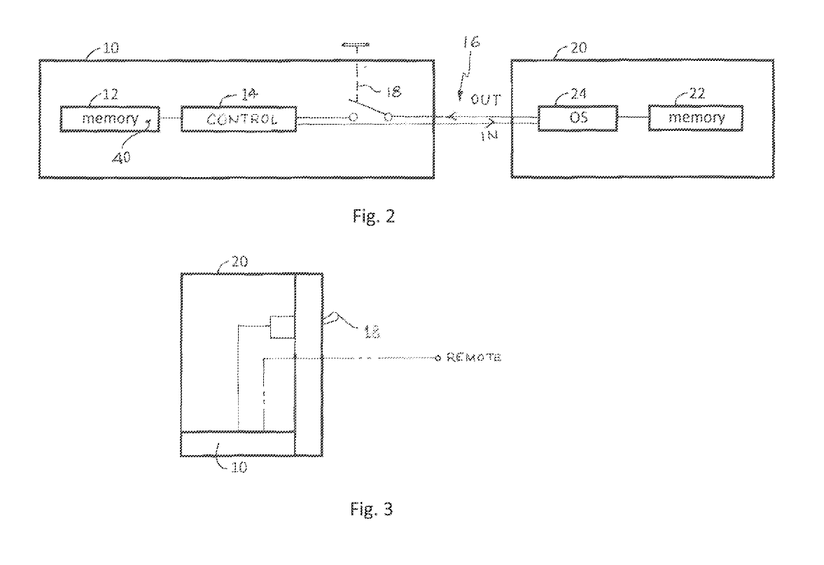

A method of operation of a circuit 10 is described herein. In one aspect of the method a host computer 20 is placed into a protected mode. The method includes closing a write inhibit physical switch 18 of the circuit 10, and then executing a protection algorithm 40 which is stored in a memory chip 12 (protected memory) of the circuit 10, thereby writing copies of control tiles of the host computer 20 into the memory chip 12 and writing a copy of a user permissions log file of the host computer 20 into the memory chip 12, and finally changing a startup execute path function of the host computer 20 to initially read the copy of the user permissions log file in the memory chip 12. When this is completed, the write inhibit physical switch 18 is opened, thereby preventing subsequent writing into the copy of the user permissions log file in the memory chip 12, whereby subsequent changes to user permissions in the host computer 20 is prevented. An important step in the above method is write protecting the memory chip 12 so that the control files of the host computer 20 cannot be changed. An important feature of the above circuit 10 is the write inhibit physical switch 18. Switch 18 may be any type of electrical device that is able to open an respective electrically conductive path within circuit 10, and also close the electrically conductive path. Switch 18 may be a manually controlled switch so that it cannot be toggled via an electrical signal such as a pulse, or a data signal. Because switch 18 is only able to be controlled manually, it is impossible for a remote operator to gain access to files in memory chip 12 so that the control files, the user permissions log file, and the startup execute path function cannot be hacked, changed, overwritten, or otherwise maliciously modified. The physical switch 18 is a critical component of circuit 10 and provides a system state change that is impossible to hack, that is, make changes to the host computer's control files. As shown in FIG. 2 switch 18 may be mounted on an a flash drive, and in FIG. 3, on the front panel of the host computer 20, and/or remotely. In all cases the physical switch 18 is interconnected so as to be able to open a conductive path so that no signals may be sent over the path. A controller such as an OTI 2168 chip (not shown) may be used in the circuit 10 and the switch 18 may be mounted between the appropriate pins so as to prevent output signals from host computer 20 from being written to protected memory chip 12. In other embodiments, the switch 18 may be implemented in different ways including where it is not used to open a conductive path. In such embodiments a lesser degree of protection may be acceptable.

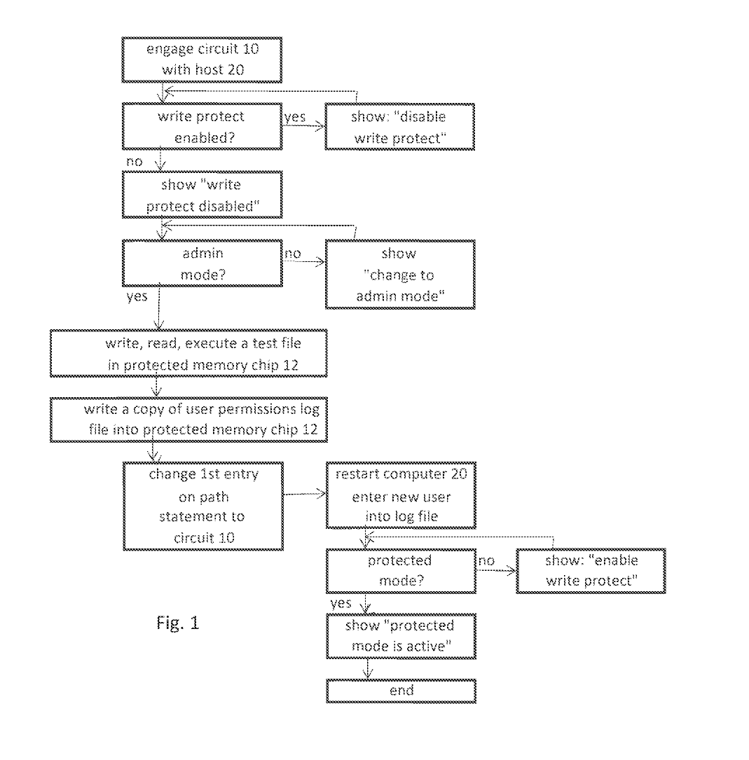

FIG. 1 illustrates the method of use of circuit 10 for protecting host computer 20. Computer 20 may be any type of digital computing device including hand-held devices, lap-top and desk-top computers, and others. Such devices may be protected from attacks as outlined in the previous background description. In summary, the function carried out by the method of circuit 10 is to isolate the control files (read, write, execute) of the host computer 20 so that an unauthorized user is not able to gain control of the operating system. This absolutely prevents the unauthorized user from making changes to software or files and especially to the host computer's permissions log.

In an embodiment, shown in FIG. 2, circuit 10 may be packaged as the well-known flash-drive or similar small portable plug-in device. In this version, circuit 10 comprises a memory chip 12, a control chip 14, an interconnect device 16, such as a USB connector, a manually operable physical switch 18, and an software algorithm 40, the latter being held in the memory chip 12. Circuit 10 may interface with the host computer 20 via one of its ports, as for instance a USB port, so that circuit 10 may be engaged and disengaged with host computer 20 at will.

In another embodiment, shown in FIG. 3, a version of circuit 10 may be permanently installed inside host computer 20 as an element of original equipment. In this embodiment no connector is required and a separate control chip 14 may not be required, as control may be handled by hardware within host computer 20. For-instance, the memory chip 12, with algorithm 40, may be mounted on the host's mother-board, a subsidiary circuit board or other internal location, and the physical switch 18 may be mounted on an exterior panel of the host computer 20 such as a front panel as shown.

As described, physical switch 18 functions as a means for breaking the electrical conductive path of data transfer between the host's operating system and circuit 10, that is, providing an open circuit condition. Switch 18 may be any type of physical electrical switching device, as for instance a single-pole, double-throw switch or similar selectable interrupter, and, as stated, switch 18 may be made physically accessible on the packaging of the embodiment of FIG. 2, or from the exterior of host computer 20. In a similar embodiment circuit 10 may operate without switch 18, the switching function being carried out by inserting or removing circuit 10 from a port of host computer 20.

As is well known in the art, host computer 20, a typical computer system, has firmware defining control files, an operating system and a control path, that is, a data signal path, used for accessing the control files which enable data reading, writing, and execution functions. It should be realized that without access to the control files it is impossible to make changes to existing user accounts and logs, and therefore it is impossible to change user privileges in host computer 20.

Referring now to FIG. 1 a method of operation is now described. Once circuit 10 is engaged with host computer 20, or is permanently engaged, upon starting computer 20 an auto-start function initiates algorithm 40 which determines the status of switch 18, the write protect system state. If switch 18 is open (write protect is enabled), “disable write protect” is presented or shown on the host computer's monitor. Algorithm 40 will not process further until switch 18 is closed whereby, “write protect is disabled” is presented on the monitor. Algorithm 40 next determines if host computer 20 is in administrator mode (“admin mode”), and if not, “change to admin mode” is shown on host's monitor. This is an important function in order to assure that present user is qualified to continue. Algorithm 40 will not process further until admin mode is entered. When admin mode is entered, a log file program is initiated by algorithm 40. This program writes, reads, and executes a test file on the host computer's root drive, for example the “C” drive on Windows operating systems. Next, algorithm 40 reads the operating system's path statement and changes the first entry in the path statement to memory chip 12. Next, algorithm 40 sets up a new user in memory chip 12 and then checks if switch 18 is open, “protected mode is active” is displayed. Finally, host computer 20 is auto-restarted.

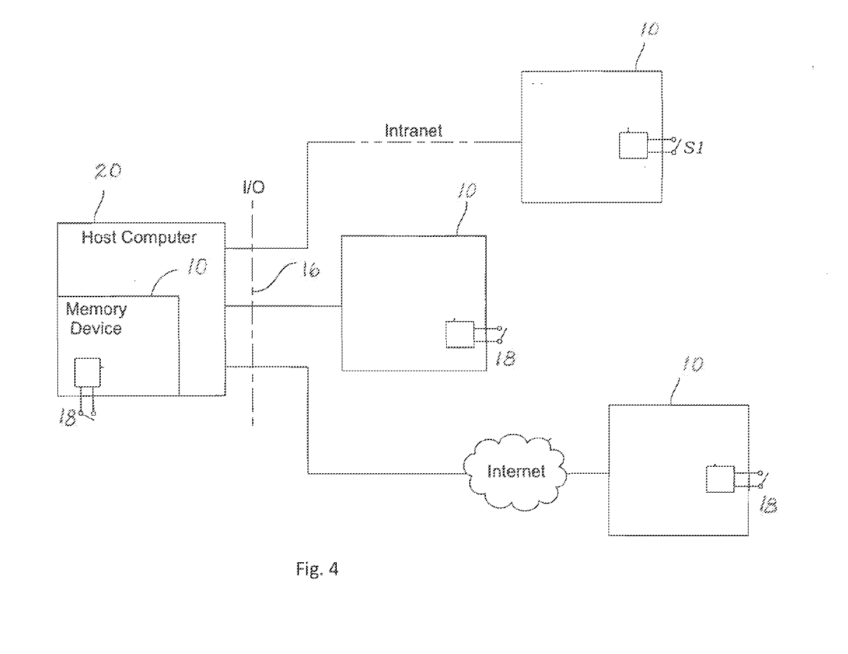

FIG. 4 shows the universal adaptability of the circuit 10 in that it may be made a part of the host computer 20, or it may be interconnected with the host computer 20 via a common intranet, directly through a USB or other port as previously described, or via the Internet.

In summary, the method of circuit 10, when in mutual signal communication with host computer 20, is initiated by booting and then executing algorithm 40 either by the well-known “autoplay” function or otherwise, which initially checks for current user permissions. Assuming the current user has administrator permissions, algorithm 40 sets up a new user account for the current user providing limited user permissions. Next, algorithm 40 copies the host computer's control files into memory 14 and then changes the control files path, superseding it with a defined control file path in memory chip 12 so that all attempts to read, write, or execute a file within host computer 20 must be accomplished by access to memory chip 12. Next, the current user is prompted to open switch 18 thereby breaking, the data input signal path between host computer 20 and memory chip 12.

Embodiments of the subject Circuit and method have been described herein. Nevertheless, it will be understood that various modifications may be made without departing from the spirit and understanding of this disclosure. Accordingly, other embodiments and approaches are within the scope of the following claims.

What is claimed is:

1. A method of placing a host computer into a protected mode, the method comprising:
closing a write inhibit physical switch of a circuit;
executing a protection algorithm stored in a protected memory of the circuit, thereby;
a) writing copies of control files of the host computer into the protected memory;
b) writing a copy of a user permissions log file of the host computer into the protected memory;
c) changing a startup execute path function of the host computer to initially read the copy of the user permissions log file in the protected memory; and
opening the write inhibit physical switch, thereby preventing writing into the copy of the user permissions log file in the protected memory, whereby changes to user permissions in the host computer is prevented.

2. A method of placing a host computer into a protected mode, the method comprising write protecting a memory of the host computer, the memory having therein control files of the host computer, whereby changes to the control files is impossible.

3. The method of claim 2 wherein the write protecting is enabled by opening a conductive path of a write protection circuit.

4. A host computer having a protected mode, the computer comprising:
a circuit having a write inhibit physical switch enabled for opening a write permissions path;
a protection algorithm stored in a protected memory of the circuit, the protection algorithm including:
a) an instruction enabling writing copies of control files of the host computer into the protected memory;
b) an instruction enabling writing a copy of a user permissions log file of the host computer into the protected memory;
c) an instruction enabling changing a startup execute path function of the host computer to initially read the copy of the user permissions log file in the protected memory; and
wherein with the write inhibit physical switch in an open state, writing into the copy of the user permissions log file is prevented.

5. A computer readable memory storing a computer algorithm executable by a processor, for pacing a host computer into a protected mode, the computer algorithm comprising:
a) an instruction enabling writing copies of control files of the host computer into the protected memory;
b) an instruction enabling writing a copy of a user permissions log file of the host computer into the protected memory;
c) an instruction enabling changing a startup execute path function of the host computer to initially read the copy of the user permissions log file in the protected memory; and
whereby with a write inhibit physical switch in an open state, writing into the copy of the user permissions log file is prevented.

6. A computer comprising:
a physical means adapted for isolating an operating system of the computer, wherein the operating system is capable of controlling changes to allowed users and for controlling changes of user permission levels.
